(19) United States
(12) Patent Application Publication
(10) Pub. No.: US 2014/0139023 A1
(43) Pub. Date: May 22, 2014

(54) APPARATUS AND METHOD FOR CONTROLLING SELF-POWER CONSUMPTION

(71) Applicant: ELECTRONICS AND TELECOMMUNICATIONS RESEARCH INSTITUTE, Daejeon (KR)

(72) Inventors: Tae in HWANG, Daejeon (KR); Il Woo LEE, Daejeon (KR)

(73) Assignee: ELECTRONICS AND TELECOMMUNICATIONS RESEARCH INSTITUTE, Daejeon (KR)

(21) Appl. No.: 14/080,947

(22) Filed: Nov. 15, 2013

(30) Foreign Application Priority Data
Nov. 20, 2012 (KR) 10-2012-0131705

(51) Int. Cl. H02J 4/00

(52) U.S. Cl. CPC H02J 4/00
USPC 307/31

(57) ABSTRACT

An apparatus for controlling a self-power consumption includes an information receiving unit configured to receive a power supply and demand situation and power price information through a wire/wireless communication network. The apparatus includes a self-power consumption control unit configured to compare the power supply and demand situation with a predetermined power situation and produce a control signal to control a plurality of appliances when it is determined that the power supply and demand situation is put in a state of emergency, or the power price exceeds a predetermined threshold. The apparatus includes a standby power status control unit configured to select one or more appliances of the appliances in response to the control signal and switch the selected appliances into a standby power state.

### RELATED APPLICATIONS

This application claims the benefit of Korean Patent Application No. 10-2012-0131705 filed on Nov. 20, 2012, which is hereby incorporated by reference as if fully set forth herein.

### FIELD OF THE INVENTION

The present invention relates to a power consumption control, and more particularly, to an apparatus and method for controlling a self-power consumption, which receives in real time a power supply and demand situation and power price information through a broadcast channel under a smart grid environment and automatically switches into a standby power state at an emergency of the power supply and demand or a sudden rise of the power price to response in real time a peak power load, thereby minimizing the self-power consumption.

### BACKGROUND OF THE INVENTION

Home appliances were a simple load device capable of controlling a power consumption autonomously in accordance with a manual operation handling by a user and a power-saving mode program of devices. In a recent, as they are networked and become intelligent gradually, they have evolved in a way that minimizes the power consumption and power rate in conjunction with information on real-time external electricity grid and power market. In particular, it has been generalized that an in-home energy management system integrally controls the home appliances in compliance with a home energy management policy set by the user and a demand response policy of power companies after receiving the reliability of the electricity grid and power price information from an integrated power control center.

In such a scheme, it is necessary to establish a standard interface for an exchange of information between the home energy management system and various home appliances and a standard interface for a device control to guarantee interoperability therebetween. However, because the standards for exchanging power information and the control of home appliances are put in a jumbled state and the power consumption control functions are different depending on characteristics for the respective appliances, it is difficult to ensure the interoperability between the appliances. Further, in order to automate the direct load control at an emergency of the power supply and demand, it is need to standardize not only the interface between an information providing server for the power supply and demand and the home energy management system, but also the interface between a demand response server of a power company and the home energy management system which monitors an entire state of the power supply and demand. Since control commands are propagated through such complex interfaces, it is difficult to respond quickly to the peak power load. In addition, such a complex control structure may cause problems on a system reliability.

### SUMMARY OF THE INVENTION

In view of the above, the present invention provides an apparatus and method for controlling a self-power consumption, which is capable of receiving in real time a power supply and demand situation and power price information through a broadcast channel to minimize the power consumption of home appliances in a state of emergency of the power supply and demand or a sudden rise of the power price.

Further, the present invention provides an apparatus and method for controlling a self-power consumption, which is capable of receiving a power supply and demand situation and power price information through a multicast broadcast channel to response to a peak power load in real time in order to solve the system complexity of a direct load control scheme by way of a demand response server of a power company and a home network and the interoperability between the home appliances.

In accordance with an exemplary embodiment of the present invention, there is provided an apparatus for controlling a self-power consumption, which includes: an information receiving unit configured to receive a power supply and demand situation and power price information through a wire/wireless communication network; a self-power consumption control unit configured to compare the power supply and demand situation with a predetermined power situation and produce a control signal to control a plurality of appliances when it is determined that the power supply and demand situation is put in a state of emergency, or the power price exceeds a predetermined threshold; and a standby power status control unit configured to select one or more appliances of the appliances in response to the control signal and switch the selected appliances into a standby power state.

In the embodiment, the apparatus further includes; an operational status backup memory unit configured to store information on an operation status of the selected appliances before switching into the standby power state.

In the embodiment, the self-power consumption control unit is configured to control the selected appliances on a basis of the information on the operation status that is stored in the operational status backup memory unit when the power supply and demand situation is revoked from the state of emergency, or the power price becomes lower than a predetermined threshold.

In the embodiment, the information receiving unit is configured to receive the power supply and demand situation or the power price information through a broadcast channel.

In the embodiment, the information receiving unit comprises a broadcast TV tuner which receives a broadcast stream to filter data that is received only through the broadcast channel from the broadcast stream.

In the embodiment, the self-power consumption control unit is configured to allow status information of the controlled power consumption of the plurality of the appliances, the power price information or the power supply and demand situation to display on a display unit.

In the embodiment, the apparatus is incorporated in a broadcast receiving apparatus which is capable of connecting to the wire/wireless communication network.

In accordance with another aspect of the exemplary embodiment of the present invention, there is a method for controlling a self-power consumption, which includes: receiving a power supply and demand situation and power price information through a wire/wireless communication network; comparing the power supply and demand situation with a predetermined power supply and demand situation or determining whether the power supply and demand situation is put in a state of emergency, or the power price exceeds a predetermined threshold to judge whether there needs a power control; and when it is judged that there needs the power control, selecting one or more appliances from the plurality of appliances to switch the selected appliances into a standby power state.

In the embodiment, the receiving the power supply and demand situation and power price information includes: receiving the power supply and demand situation and power price information through a broadcast channel.

In the embodiment, the receiving the power supply and demand situation and power price information includes: receiving a broadcast stream; and filtering data corresponding to the broadcast channel from the broadcast stream.

In the embodiment, the method further includes: when it is judged that there needs the power control, storing information on an operation status of the plurality of the appliances before switching the appliances into the standby power state.

In the embodiment, the method further includes: when there needs not the power control after switching the appliances into the standby power state, recovering the operation status of the plurality of the appliances on a basis of the operation status information that has been stored.

In accordance with an embodiment of the present invention, it is possible to receive a power supply and demand situation and power price information through a multicast broadcast channel under a smart grid environment to response a peak power load in real time, thereby integrally controlling the home appliances through the multicast broadcast channel. Therefore, the embodiment present invention may be utilized as a technique to prevent in advance a state of a large scale power failure that may happen in the emergency of a power supply and demand.

Further, the present invention directly transmits the power supply and demand situation and power price information between a server for providing the power supply and demand and the home appliances through the multicast broadcast channel; and therefore, it is possible to unify the interfaces for securing the interoperability between the appliances and the system and minimize the network traffic, thereby simplifying the entire system structure for controlling the power consumption. Further, the embodiment of the present invention enables the home appliances to rapidly and actively minimize the self-power consumption in a state of emergency of the power supply and demand based on the information on the power supply and demand situation, thereby giving aid in the stabilization of the power supply and demand and contributing to save the power rate.

### BRIEF DESCRIPTION OF THE DRAWINGS

The above and other objects and features of the present invention will become apparent from the following description of the embodiments given in conjunction with the accompanying drawings, in which:

FIG. 1 is a block diagram of a system for controlling a self-power consumption of home appliances based on a power supply and demand situation and power price information received through a multicast broadcast channel under a smart grid environment in accordance with an embodiment of the present invention;

FIG. 2 is a detailed block diagram of the self-power consumption control apparatus in accordance with an embodiment of the present invention; and

FIG. 3 is a flow diagram illustrating a process of controlling a self-power consumption by the self-power consumption control apparatus in accordance with an embodiment of the present invention.

### DETAILED DESCRIPTION OF THE EMBODIMENTS

Hereinafter, the embodiments of the present invention will be described in detail with reference to the accompanying drawings.

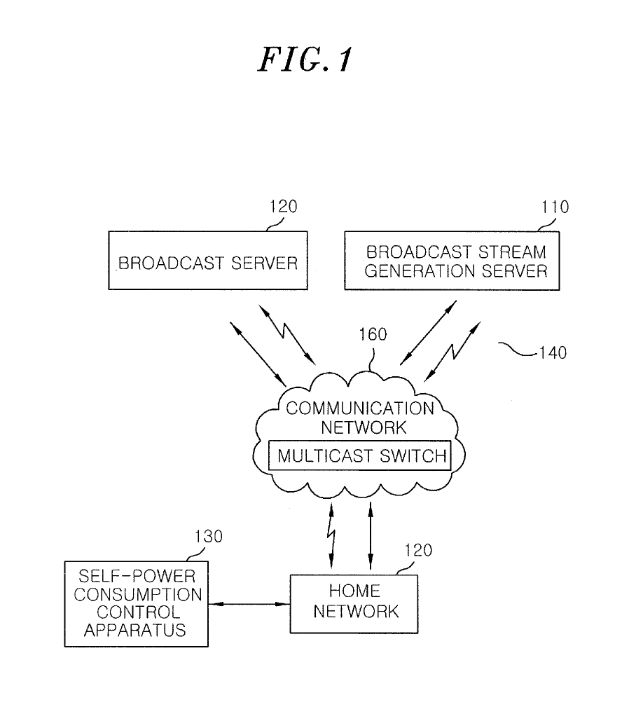

FIG. 1 is a block diagram of a system for controlling a self-power consumption of home appliances based on a power supply and demand situation and power price information received through a multicast broadcast channel under a smart grid environment in accordance with an embodiment of the present invention. The system includes a broadcast stream generation server 110, a broadcast server 110, a self-power consumption control apparatus 130, and a multicast switch 140, a home network the home network 150, and a communication network 160. The system is capable of receiving in real time a power supply and demand situation and power price information through a broadcast channel under a smart grid environment and automatically switching home appliances in the home network 150 into a standby power state at an emergency of the power supply and demand or at a sudden rise of the power price, to thereby respond the peak power load in real time and minimize the self-power consumption.

Referring to FIG. 1, the broadcast stream generation server 110 generates the power supply and demand situation and power price information in a form of a broadcast stream. The generated broadcast stream is transmitted to the home appliances in the home network 150, e.g, home appliances which have subscribed to the broadcast channel.

The broadcast server 120 receives the broadcast stream from the broadcast stream generation server 110 which is connected through the communication network 160 and transmits the broadcast stream to the appliances in the home network 150 through the multicast switch 140. The broadcast stream may be transmitted to the self-power consumption control apparatus 130 in a multicast scheme from the broadcast server 120 through the communication network 160.

The self-power consumption control apparatus 130 controls the self-power consumption of the appliances on a basis of the power supply and demand situation and power price information. More specifically, when the power supply and demand situation is put in a state of emergency or the power price information exceeds a predetermined threshold, the self-power consumption control apparatus 130 switches a portion of or all of the appliances in the home network 150 into a standby power status.

Further, the self-power consumption control apparatus 130 may judge again whether to control the self-power consumption by monitoring the power supply and demand situation and power price information in real time after switching the appliances into the standby power status.

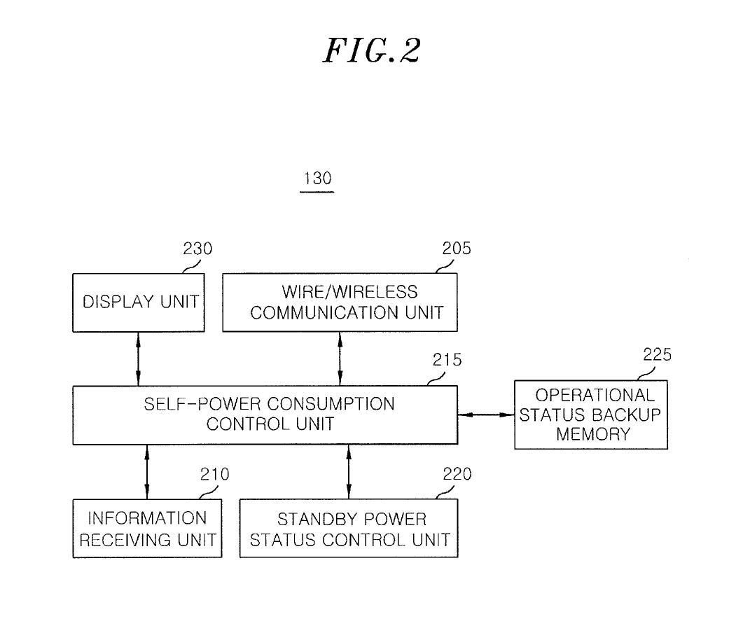

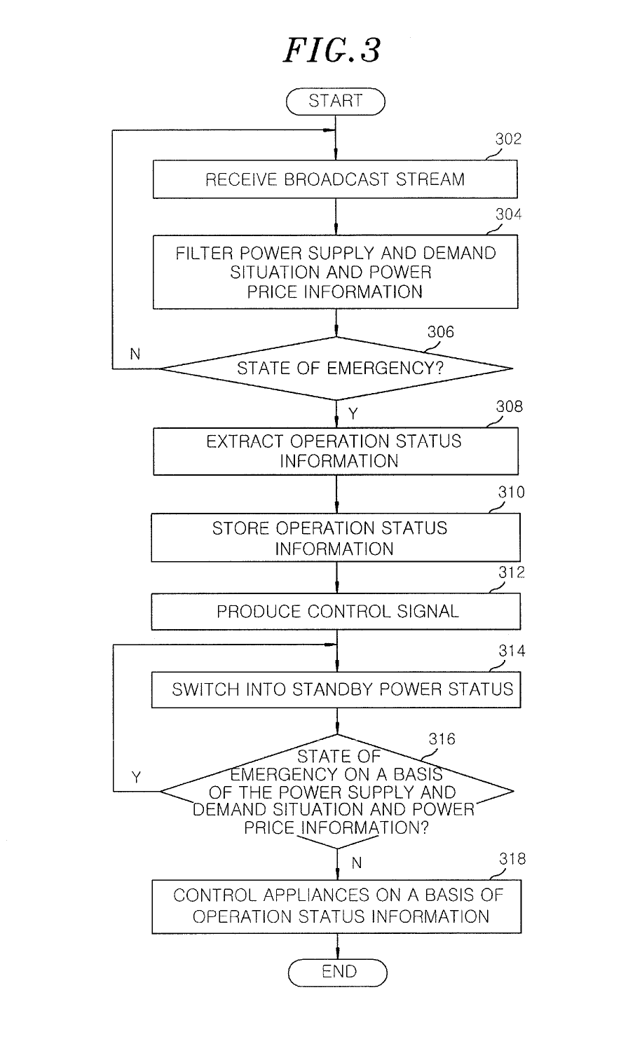

The operation of the self-power consumption control apparatus 130 will be described with reference to FIGS. 2 and 3.

Meanwhile, the self-power consumption control apparatus 130 may be installed in separate devices in the home network the home network the home network 150, or may be installed or incorporated in devices which are capable of receiving the power supply and demand situation and the power price information in conjunction with the appliances.

The multicast switch 140 transmits the broadcast stream received from the broadcast server 120 to the home network 150 at which the appliances owned by a channel subscriber are located.

Connected to the home network 150 is a plurality of home appliances of which consumed electric power is controlled by the self-power consumption control apparatus 130.

The communication network 160 may include a wired network such as the wired Internet, a wireless network such as Wi-Fi (Wireless Fidelity) and WiBro (Wireless Broadband), a wireless mobile communication network such as 3G, 4G, LTE, and a private network. The private network may be a network used to perform a data communication between the broadcast stream generation server 110 and the broadcast server 120.

Hereinafter, the components and operation of the self-power consumption control apparatus 130 having the configuration as set forth above will be described in detail as below.

FIG. 2 is a block diagram of the self-power consumption control apparatus 130 in accordance with an embodiment of the present invention. The self-power consumption control apparatus 130 includes a wire/wireless communication unit 205, an information receiving unit 210, a self-power consumption control unit 215, a standby power state control unit 220, an operational status backup memory unit 225, and a display unit 230.

The wire/wireless communication unit 205 is connected to the communication network 160 via a wire/wireless router (not shown) mounted in the home network 150 or directly connected to the communication network 160 and receives the broadcast stream.

The information receiving unit 210 filters required information from the broadcast stream that is received through the wire/wireless communication unit 205, e.g., the power supply and demand situation and power price information. This information receiving unit 210 may include a broadcast TV tuner, but is not limited thereto.

The self-power consumption control unit 215 produces a control signal to control the plurality of appliances on a basis of the power supply and demand situation and power price information that are received through the information receiving unit 210, and perceives an operation status of the appliances in predetermined time intervals or before switching the appliances into the standby power state to store information on the perceived operation status into the operational status backup memory unit 225.

In other words, when the power supply and demand situation is put in a state of emergency or the power price exceeds a predetermined threshold, the self-power consumption control unit 215 produces a control signal which will be used to switch a portion of or all of the appliances into the standby power state. The control signal is then applied to the standby power status control unit 220.

In response to the control signal, the standby power status control unit 220 switches a portion of or all of the appliances into the standby power state.

Meanwhile, after a portion of or all of the appliances are switched into the standby power state, the self-power consumption control unit 215 determines whether the power supply and demand situation and the power price returns to a normal state (that is, the power supply and demand situation returns to a normal state, or the power price becomes lower than a predetermined threshold). When it is determined that the power supply and demand situation and a power price information return to the normal state, the self-power consumption control unit 215 controls the appliances that have been switched into the standby power state. That is, the appliances that have been switched into the standby power state can be recovered into a previous status using the operation status information that has been stored in the operational status backup memory unit 225.

In addition, the self-power consumption control unit 215 allows the display unit 230 to display the power supply and demand situation, the power price information, a status of controlled power consumption of the appliances, an overall power consumption status and the like.

While it has been described that the self-power consumption control apparatus 130 is constructed as a separate apparatus as an example, the self-power consumption control apparatus 130 may be installed on an appliance having a tuner capable of receiving broadcast channels, e.g., a television set, a computer, a wireless terminal, and the like, or in a form of a program. In this case, the information receiving unit 210 in the self-power consumption control apparatus 130 may be substituted to a tuner in the appliance, and the operational status backup memory unit in the self-power consumption control apparatus 130 may be substituted to a storage medium in the appliance.

The control flow of controlling the power consumption by the self-power consumption control apparatus 130 having such configuration as set forth above will be described with reference to FIG. 3.

FIG. 3 is a flow diagram illustrating a process of controlling a self-power consumption in accordance with an embodiment of the present invention.

Referring to FIG. 3, in an operation 302, the self-power consumption control apparatus 130 receives a broadcast stream in real time from the broadcast server 120 that is connected through the wire/wireless communication unit 205 when the plurality of appliances consume the electric power during their operations.

The information receiving unit 210 filters required data from the broadcast stream, i.e., a power supply and demand situation and power price information, in an operation 304. The filtered data is then provided to the self-power consumption control unit 215.

Subsequently, in an operation 306, the self-power consumption control unit 215 determines whether it is put in a state of emergency on a basis of the power supply and demand situation and the power price information. That is, it is determined whether the present is a state of emergency by checking whether the power supply and demand situation is put in a state of emergency or the power price exceeds a predetermined threshold.

As a result of the determination of the operation 306, it is determined that the present is a state of emergency, the self-power consumption control unit 215 extracts information on the operation status of a portion of or all of the appliances, in an operation 308, and stores the extracted operation status information in the operational status backup memory unit 225, in an operation 310.

Thereafter, the self-power consumption control unit 215 produces a control signal to allow switching a portion of or all of the appliances into the standby power state, in an operation 312 and provides the control signal to the standby power status control unit 220.

In response to the control signal, the standby power status control unit 220 switches a portion of or all of the appliances into the standby power state, in an operation 314.

After the appliances has been switched into the standby power state, the self-power consumption control unit 215 determines continuously whether the present is a state of emergency on a basis of the power supply and demand situation and the power price information, in an operation 316.

As a result of the judgment of the operation 316, it is determined that it is a normal state, i.e., that the power supply and demand situation is revoked from the state of emergency, or the power price becomes lower than a predetermined threshold, the self-power consumption control unit 215 obtains information on the operation status from the operational status backup memory unit 225 and changes a portion of or all of the appliances into their previous statuses using their operation status information, in an operation 318.

Meanwhile, as a result of the determination of the operation 316, when it is determined that it is a state of emergency, the process returns to the operation 314 where the self-power consumption control unit 215 sustains the standby power state and repeatedly continues to the above described operations.

As set forth above, in accordance with an embodiment of the present invention, a power supply and demand situation and power price information are directly transmitted through a multicast broadcast channel to the self-power consumption control apparatus 130 which is interworking with the home network 150, thereby unifying the interfaces for securing the interoperability between the appliances and the system and minimizing the network traffic, which results in simplifying the entire system structure for controlling the power consumption.

Further, it is possible to rapidly and actively minimize the self-power consumption in a state of emergency of the power supply and demand based on the information on the power supply and demand situation, thereby giving aid in the stabilization of the power supply and demand and contributing to save the power rate.

While the description of the present invention has been made to the exemplary embodiments, various changes and modifications may be made without departing from the scope of the invention. The embodiment of the present invention is not limited thereto. Therefore, the scope of the present invention should be defined by the appended claims rather than by the foregoing embodiments.

What is claimed is:

1. An apparatus for controlling a self-power consumption, the apparatus comprising:
an information receiving unit configured to receive a power supply and demand situation and power price information through a wire/wireless communication network;
a self-power consumption control unit configured to compare the power supply and demand situation with a predetermined power situation and produce a control signal to control a plurality of appliances when it is determined that the power supply and demand situation is put in a state of emergency, or the power price exceeds a predetermined threshold; and
a standby power status control unit configured to select one or more appliances of the appliances in response to the control signal and switch the selected appliances into a standby power state.

2. The apparatus of claim 1, further comprising:
an operational status backup memory unit configured to store information on an operation status of the selected appliances before switching into the standby power state.

3. The apparatus of claim 2, wherein the self-power consumption control unit is configured to control the selected appliances on a basis of the information on the operation status that is stored in the operational status backup memory unit when the power supply and demand situation is revoked from the state of emergency, or the power price becomes lower than a predetermined threshold.

4. The apparatus of claim 1, wherein the information receiving unit is configured to receive the power supply and demand situation or the power price information through a broadcast channel.

5. The apparatus of claim 4, wherein the information receiving unit comprises a broadcast TV tuner which receives a broadcast stream to filter data that is received only through the broadcast channel from the broadcast stream.

6. The apparatus of claim 1, wherein the self-power consumption control unit is configured to allow status information of the controlled power consumption of the plurality of the appliances, the power price information or the power supply and demand situation to display on a display unit.

7. The apparatus of claim 1, wherein the apparatus is incorporated in a broadcast receiving apparatus which is capable of connecting to the wire/wireless communication network.

8. A method for controlling a self-power consumption, the method comprising:
receiving a power supply and demand situation and power price information through a wire/wireless communication network;
comparing the power supply and demand situation with a predetermined power supply and demand situation or determining whether the power supply and demand situation is put in a state of emergency, or the power price exceeds a predetermined threshold to judge whether there needs a power control; and
when it is judged that there needs the power control, selecting one or more appliances from the plurality of appliances to switch the selected appliances into a standby power state.

9. The method of claim 8, wherein said receiving the power supply and demand situation and power price information comprises:
receiving the power supply and demand situation and power price information through a broadcast channel.

10. The method of claim 9, wherein said receiving the power supply and demand situation and power price information comprises:
receiving a broadcast stream; and
filtering data corresponding to the broadcast channel from the broadcast stream.

11. The method of claim 8, further comprising:
when it is judged that there needs the power control, storing information on an operation status of the plurality of the appliances before switching the appliances into the standby power state.

12. The method of claim 11, further comprising:
when there needs not the power control after switching the appliances into the standby power state, recovering the operation status of the plurality of the appliances on a basis of the operation status information that has been stored.
